(19) United States
(12) Patent Application Publication
(10) Pub. No.: US 2024/0132091 A1
(43) Pub. Date: Apr. 25, 2024

(54) DRIVING SUPPORT DEVICE, DRIVING SUPPORT METHOD, AND DRIVING SUPPORT PROGRAM

(71) Applicant: TOYOTA JIDOSHA KABUSHIKI KAISHA, Toyota-shi (JP)

(72) Inventor: Yusuke FUKUI, Miyoshi-shi (JP)

(73) Assignee: TOYOTA JIDOSHA KABUSHIKI KAISHA, Toyota-shi (JP)

(21) Appl. No.: 18/343,985

(22) Filed: Jun. 28, 2023

(30) Foreign Application Priority Data
Oct. 18, 2022 (JP) 2022-167464

(51) Int. Cl. B60W 50/14; B60W 40/04; B60W 40/08

(52) U.S. Cl. CPC B60W 50/14; B60W 40/04; B60W 40/08; B60W 2050/143; B60W 2050/146; B60W 2554/80

(57) ABSTRACT

Provided is a driving support device (1) including: a front sensor configured to detect a traffic participant existing in a predetermined region on a left front side and a right front side of an own vehicle, and to acquire information on the traffic participant; a warning device configured to execute warning for an occupant of the own vehicle; and a processor configured to control the warning device. The processor is configured to: predict, when a turn intention that is an intention of a driver to turn the own vehicle toward a side on which the traffic participant exists is detected within a predetermined time from a first time point at which the front sensor comes to be unable to detect the traffic participant due to deviation of the traffic participant from the region as a result of approach of the own vehicle to the traffic participant, based on the information on the traffic participant before the first time point, a distance between the traffic participant and the own vehicle in a front-rear direction at a second time point at which the turn intention is detected; and cause the warning device to execute the warning when the predicted distance between the traffic participant and the own vehicle in the front-rear direction is within a predetermined range.

### BACKGROUND OF THE INVENTION

### 1. Field of the Invention

The present invention relates to a driving support device, a driving support method, and a driving support program which suppress a collision with (hook collision with) a traffic participant existing on a lateral side of an own vehicle when the own vehicle turns left or turns right.

### 2. Description of the Related Art

In general, when an own vehicle turns left (or turns right), it is difficult for a driver of this own vehicle to visually recognize a traffic participant (such as a pedestrian, a bicycle, or a motorcycle) positioned on the left side (or the right side) of the own vehicle. Thus, in general, there has been proposed a device which includes a front sensor for acquiring information on a traffic participant positioned in front of the own vehicle, and executes control of suppressing a collision between the traffic participant and the own vehicle based on information acquired by this front sensor. However, there is a case in which a detection range of the front sensor is limited to the front side of the own vehicle, and does not cover lateral sides of the own vehicle. That is, there is a case in which it is difficult to use the front sensor mounted to the own vehicle to detect the traffic participant positioned on the left side (or the right side) of the own vehicle when the own vehicle turns left (or turns right).

Thus, a processor (a calculation device mounted to an own vehicle) of a driving support device (hereinafter referred to as “related-art device”) as described in Japanese Patent Application Laid-open No. 2008-293099 acquires, from another vehicle positioned in the rear of the own vehicle via a wireless communication line, information which is acquired by a front sensor of the another vehicle and is on a traffic participant positioned on a lateral side of the own vehicle. After that, the processor of the related-art device can issue predetermined warning based on the acquired information. As a result, a collision between the traffic participant positioned on the left side (or the right side) of the own vehicle and the own vehicle is suppressed when the own vehicle turns left (or turns right).

The above-mentioned related-art device assumes that another vehicle including the front sensor exists in the rear of the own vehicle. When such another vehicle does not exist, the processor of the related-art device cannot acquire the information on a traffic participant positioned on the lateral side of the own vehicle. Thus, in this case, the related-art device does not issue the warning even when a traffic participant exists on the left side (or the right side) of the own vehicle at the time of the left turn (or the right turn) of the own vehicle.

### SUMMARY OF THE INVENTION

One object of the present invention is to provide a driving support device capable of increasing safety at the time when an own vehicle turns left or turns right.

In order to achieve the above-mentioned object, according to at least one embodiment of the present invention, there is provided a driving support device (1) including: a front sensor (20) configured to detect a traffic participant (A) existing in a predetermined region on a left front side and a right front side of an own vehicle, and to acquire information on the traffic participant; a warning device (30) configured to execute warning for an occupant of the own vehicle; and a processor (10) configured to control the warning device. The processor is configured to: predict, when a turn intention that is an intention of a driver to turn the own vehicle toward a side on which the traffic participant exists is detected within a predetermined time from a first time point (t1) at which the front sensor comes to be unable to detect the traffic participant due to deviation of the traffic participant from the predetermined region as a result of approach of the own vehicle to the traffic participant, based on the information on the traffic participant before the first time point, a distance (ΔYt2) between the traffic participant and the own vehicle in a front-rear direction at a second time point (t2) at which the turn intention is detected; and cause the warning device to execute the warning when the predicted distance between the traffic participant and the own vehicle in the front-rear direction is within a predetermined range.

When the state in which the own vehicle is positioned in the rear of the traffic participant and hence the front sensor can recognize the traffic participant transitions to the state in which the own vehicle approaches the traffic participant and hence the traffic participant deviates from the detection range of the front sensor, the front sensor comes to be unable to recognize the traffic participant. After that, the processor causes the warning device to execute the warning when the own vehicle and the traffic participant are predicted to be close to each other at the second time point at which the processor detects that the driver intends to turn the own vehicle toward the traffic participant side. As described above, according to the at least one embodiment of the present invention, even when a device (for example, another vehicle positioned in the rear of the own vehicle) which supplies the information on a traffic participant which cannot be detected by the front sensor of the own vehicle does not exist, the warning can be issued based only on the information acquired by the front sensor mounted to the own vehicle. As a result, the safety of the own vehicle can be increased.

In the driving support device according to one aspect of the present invention, the processor is configured to: acquire, based on the information on the traffic participant, a distance (1X) between the own vehicle and the traffic participant in a vehicle width direction, the distance (1Y) between the own vehicle and the traffic participant in the front-rear direction, and a speed (va) of the traffic participant in the front-rear direction; and predict the distance between the traffic participant and the own vehicle in the front-rear direction at the second time point when the processor detects that the distance in the vehicle width direction is equal to or shorter than a predetermined threshold value, and the front sensor comes to be unable to detect the traffic participant due to the deviation of the traffic participant from the predetermined region as a result of a decrease in the distance between the own vehicle and the traffic participant in the front-rear direction.

Under a situation in which the traffic participant and the own vehicle are traveling along the same lane (are traveling in parallel with each other), both thereof possibly come in contact with each other when the own vehicle turns toward the traffic participant side. In this aspect, the traffic participant and the own vehicle are considered to be traveling in parallel with each other when the distance between both thereof in the vehicle width direction is equal to or shorter than the threshold value. Moreover, the driving support device is configured to execute the warning only when this condition is satisfied. With this configuration, unnecessary execution of the warning is suppressed.

In the driving support device according to another aspect of the present invention, the processor is configured to predict the distance between the traffic participant and the own vehicle at the second time point while assuming that the traffic participant has traveled at a constant speed being a speed at the first time point in a period from the first time point to the second time point.

With this configuration, the processer can relatively easily predict the distance between the traffic participant and the own vehicle at the second time point.

Moreover, a driving support method and a driving support program according to at least one embodiment of the present invention include steps executed by each device forming the above-mentioned driving support device.

### BRIEF DESCRIPTION OF THE DRAWINGS

FIG. 1 is a block diagram of a driving support device according to at least one embodiment of the present invention.

FIG. 2 is a plan view for illustrating a detection range of a front sensor.

FIG. 3 is a plan view for illustrating a distance between an own vehicle and a traffic participant in a vehicle width direction and a distance therebetween in a front-rear direction.

FIG. 4A to FIG. 4C are plan views for illustrating an example of a change in the distance between the own vehicle and the traffic participant in the front-rear direction.

FIG. 5 is a graph for showing an example of the change in the distance between the own vehicle and the traffic participant in the front-rear direction.

FIG. 6 is a flowchart of a program for implementing a warning function.

### DESCRIPTION OF THE EMBODIMENTS

(Overview)

A driving support device 1 according to at least one embodiment of the present invention is mounted to a vehicle V (hereinafter referred to as “own vehicle”) having a self-driving function. The driving support device 1 has a function (warning function) of issuing predetermined warning when a traffic participant exists on a left side (or right side) of the own vehicle at the time of left turn (or right turn) of the own vehicle, and the own vehicle highly possibly comes in contact with the traffic participant under a situation in which the self-driving function is disabled and a driver is initiatively executing a driving operation.

(Specific Configuration)

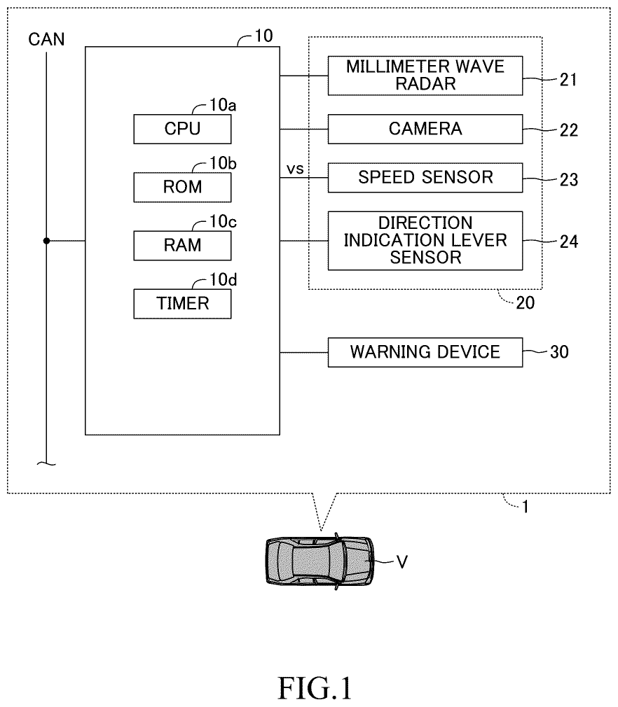

As illustrated in FIG. 1, the driving support device 1 includes a driving support ECU 10, in-vehicle sensors 20, and a warning device 30.

The driving support ECU 10 includes a microcomputer including, for example, a CPU 10a, a ROM 10b, a RAM 10c, and a timer 10d.

The driving support ECU 10 is connected to other ECUs included in the own vehicle via a controller area network (CAN).

The in-vehicle sensors 20 includes a front sensor which acquires information on a traffic participant positioned in front of the own vehicle. Specifically, the in-vehicle sensors 20 include a millimeter wave radar 21 and a camera 22 as the front sensor.

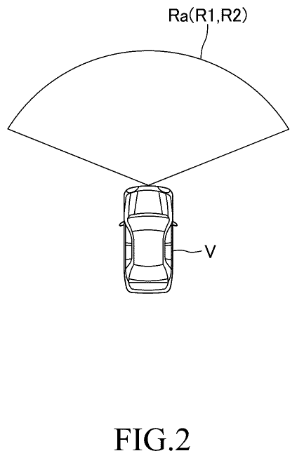

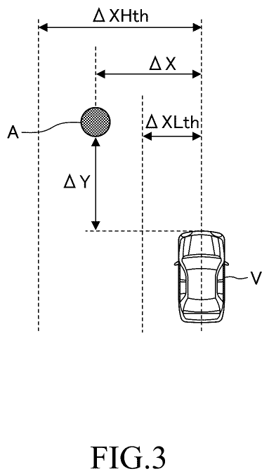

The millimeter wave radar 21 includes a transmission and reception unit and a signal processing unit (not shown). The transmission and reception unit radiates a radio wave in the millimeter waveband (hereinafter referred to as “millimeter wave”) toward the front side of the own vehicle, and receives the millimeter wave (reflected wave) reflected by a three-dimensional object including a traffic participant A (such as a pedestrian, a bicycle, or a motorcycle) positioned within a radiation range. As illustrated in FIG. 2, the radiation range of the millimeter wave presents a substantial fan shape in plan view. The signal processing unit determines whether or not a traffic participant A is recognized (detected) based on a time from the radiation of the millimeter wave to the reception of the reflected wave by the transmission and reception unit, a phase difference between the transmitted millimeter wave and the received reflected wave, an attenuation level of the reflected wave, or the like. When the signal processing unit recognizes a traffic participant A, the signal processing unit calculates a distance between the own vehicle and the traffic participant A (a distance ΔX in a vehicle width direction and a distance ΔY in a front-rear direction), a speed va of the traffic participant A toward a front direction (travel direction of the own vehicle), and the like, and transmits results of the calculation to the driving support ECU 10. As illustrated in FIG. 3, the distance ΔX is a distance between a straight line (center line) passing through a center portion of the own vehicle in the vehicle width direction and a straight line (center line) passing through a center portion of the traffic participant A in the width direction. Moreover, the distance ΔY is a distance between a front end of the own vehicle and a rear end of the traffic participant A.

The camera 22 includes an image pickup device and an image analysis device. The image pickup device is, for example, a digital camera having a built-in image pickup element being a charge-coupled device (CCD) or a CMOS image sensor (CIS). The image pickup device faces forward in an upper portion of a front windshield glass. The image pickup device captures a front region of the own vehicle at a predetermined frame rate to acquire image data. The image pickup device transmits the image data to the image analysis device. The image analysis device analyzes the acquired image data, to thereby acquire information on a traffic participant positioned in front of the own vehicle from images of the image data. For example, the image analysis device discriminates (recognizes) traffic participants (such as a pedestrian, a bicycle, and a motorcycle) and other three-dimensional objects (for example, a guard rail and a pole) existing on a left front side and a right front side of the own vehicle from each other, and transmits results of the discrimination (recognition results) to the driving support ECU 10.

As illustrated in FIG. 2, a range R1 within which the millimeter wave radar 21 can accurately detect the traffic participant A and a range R2 within which the image analysis device of the camera 22 can accurately recognize the traffic participant A are substantially the same in plan view. However, those ranges may be shifted more or less from each other. The minimum region which includes both of the above-mentioned ranges is hereinafter referred to as “detection range Ra of the front sensor.”

The in-vehicle sensors 20 further include a sensor which acquires information on a travel state (speed) of the own vehicle and information on an operation mode of an operation element included in the own vehicle.

Specifically, as illustrated in FIG. 1, the in-vehicle sensors 20 include a speed sensor 23 and a direction indication lever sensor 24.

The speed sensor 23 detects a rotation speed (wheel speed) of each wheel of the own vehicle, to thereby calculate a speed vs (actual vehicle speed) of the own vehicle based on the wheel speed of each wheel. The speed sensor 23 transmits data representing the speed vs to the driving support ECU 10.

The direction indication lever sensor 24 includes switch devices (hereinafter referred to as “right turn switch” and “left turn switch”) built into a direction indicator of the own vehicle. When a lever of the direction indicator is at a neutral position, the left turn switch and the right turn switch are in an OFF state. When the driver causes the own vehicle to travel toward the right direction, the driver pulls down this lever from the neutral position to a predetermined direction. As a result, the right turn switch is brought into an ON state. In this case, the left turn switch remains in the OFF state. Meanwhile, when the driver causes the own vehicle to travel toward the left direction, the driver turns down this lever from the neutral position to a direction opposite to the above-mentioned predetermined direction. As a result, the left turn switch is brought into the ON state. In this case, the right turn switch remains in the OFF state.

The warning device 30 includes a display device and a sound device. The display device is formed of a liquid crystal display device, a head-up display device, or the like. The display device acquires display data from the driving support ECU 10, and displays an image in accordance with this display data. The sound device is formed of an amplification device and a speaker device. The sound device acquires sound data from the driving support ECU 10, and reproduces sound in accordance with this sound data.

(Operation)

The driving support ECU 10 sequentially receives the recognition result from each of the millimeter wave radar 21 and the camera 22. When the recognition results of the millimeter wave radar 21 and the camera 22 represent that “a traffic participant A (a pedestrian, a bicycle, or a motorcycle) exists on the left front side or the right front side of the own vehicle,” the driving support ECU 10 acquires, from the millimeter wave radar 21, the distance ΔX between this traffic participant A and the own vehicle. The driving support ECU 10 may calculate the distance ΔX based on the recognition result (or the image data) of the camera 22.

When the distance ΔX between the traffic participant A and the own vehicle is equal to or longer than a lower limit threshold value ΔXLth and equal to or shorter than an upper limit threshold value ΔXHth (for example, equal to or longer than 1.5 meters and equal to or shorter than 3.5 meters) (see FIG. 3), the driving support ECU 10 acquires, from the millimeter wave radar 21, the distance ΔY between the traffic participant A and the own vehicle in the front-rear direction and the speed va. The driving support ECU 10 stores those pieces of data in the RAM 10c as pieces of time-series data (data at each time point in a period from the current time point to a time point a predetermined time ago). The lower limit threshold value ΔXLth and the upper limit threshold value ΔXHth are determined in advance as values which define a range within which the traffic participant A highly possibly moves along a lane on which the own vehicle is traveling. That is, when a traffic participant A is positioned within this range, the driving support ECU 10 determines that this traffic participant A highly possibly moves along the lane on which the own vehicle is traveling.

When the speed vs of the own vehicle is higher than the speed va of the traffic participant A, the own vehicle approaches the traffic participant A. That is, the distance ΔY decreases. When the traffic participant A deviates from the detection range Ra of the front sensor, the front sensor (both of the millimeter wave radar 21 and the camera 22) comes to be unable to recognize the traffic participant A. The driving support ECU 10 sequentially determines whether or not the distance ΔY is decreasing based on the time-series data of the distance ΔY stored in the RAM. When the front sensor (both of the millimeter wave radar 21 and the camera 22) comes to be unable to recognize the traffic participant A under the situation in which the distance ΔY is decreasing, the driving support ECU 10 starts measurement of an elapsed time ΔT from this time point (first time point t1). Moreover, the driving support ECU 10 sequentially acquires the speed vs of the own vehicle from the speed sensor 23, and stores the speed vs in the RAM 10c as time-series data.

Further, the driving support ECU 10 monitors the ON state and the OFF state of each of the right turn switch and the left turn switch of the direction indication lever sensor 24. The driving support ECU 10 determines whether or not the driver intends to turn the own vehicle based on the change in the ON state and the OFF state of both of the switches. When the left turn switch (right turn switch) is in the ON state, the driving support ECU 10 determines that the driver intends to turn the own vehicle left (right).

When the driver intends to turn the own vehicle toward the direction (left or right) in which the traffic participant A exists at a second time point t2 at which the elapsed time ΔT is equal to or shorter than a threshold value ΔTth (for example, five seconds), the driving support ECU 10 sets the speed va and the distance ΔY of the traffic participant A acquired immediately before the first time point t1 from the RAM 10c to a speed vat1 and a distance ΔYt1, respectively. Further, the driving support ECU 10 acquires, from the RAM 10c, the speed vs of the own vehicle at each time point after the first time point t1. After that, the driving support ECU 10 predicts a distance ΔYt2 between the own vehicle and the traffic participant A in the front-rear direction at the second time point t2 based on the speed vat1, the distance ΔYt1, and the speed vs of the own vehicle after the first time point t1. Specifically, the driving support ECU 10 assumes that the traffic participant A has traveled at a constant speed of the speed vat1 from the first time point t1 to the second time point t2, and calculates a distance ΔYa (=vat1×ΔT) of the travel of the traffic participant A in this period. Moreover, the driving support ECU 10 integrates the speed vs in that period, to thereby calculate a distance ΔYv of the travel of the own vehicle in that period. After that, the driving support ECU 10 acquires a value obtained by adding a difference between the distance ΔYa and the distance ΔYv to the distance ΔYt1 as the distance ΔYt2 (=ΔYt1+ΔYa−ΔYv).

When the distance ΔYt2 is equal to or longer than a threshold value ΔYLth and equal to or shorter than a threshold value ΔYHth (for example, equal to or longer than −10 meters and equal to or shorter than +1 meter), the driving support ECU 10 causes the warning device 30 to execute predetermined warning. A collision between the own vehicle and the traffic participant A is suppressed by the driver braking the own vehicle as a result of the execution of the warning.

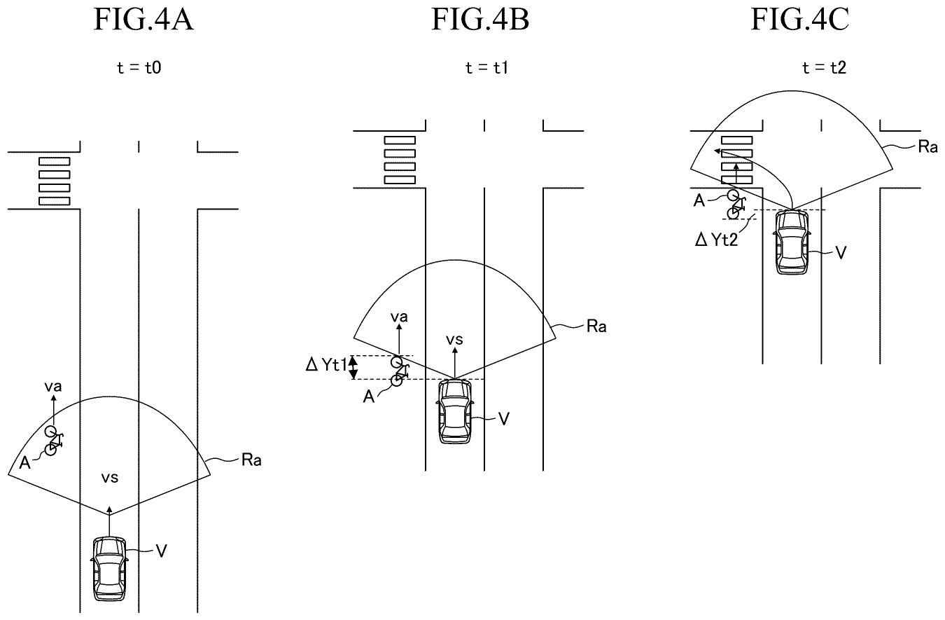

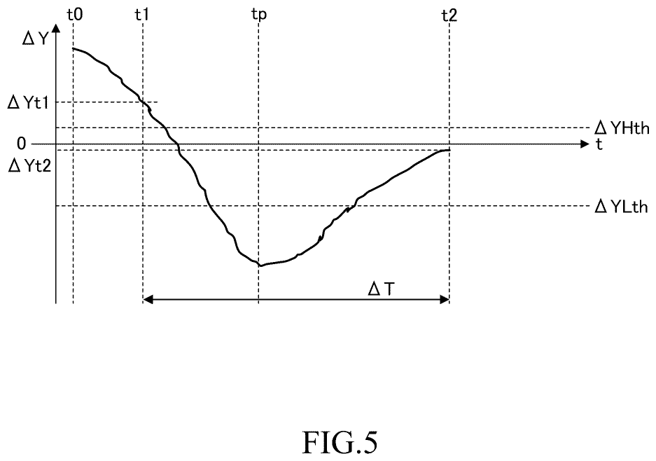

With reference to FIG. 4A, FIG. 4B, and FIG. 5, description is now given of an example in which the driving support device 1 issues the warning under a situation in which the own vehicle and a traffic participant A positioned on the left side of the own vehicle travel in the same direction toward the same intersection and then the own vehicle turns left at the intersection. FIG. 4A and FIG. 4B are views for illustrating the situation until the own vehicle and the traffic participant enter the intersection existing in front. FIG. 4A shows a situation in which the traffic participant A is traveling on the left front side of the own vehicle in the same direction as that of the own vehicle at a time point to. FIG. 4B shows a situation in which the own vehicle approaches the traffic participant A and hence the front sensor comes to be unable to recognize the traffic participant A at the first time point t1 after the time point t0. FIG. 4C shows a situation in which the driver operates the direction indication lever such that the direction indicator of the own vehicle indicates the left direction at the second time point t2 after the time point t1.

FIG. 5 is a graph for showing a change in the time series of the distance ΔY between the own vehicle and the traffic participant A. As shown in FIG. 5, the distance ΔY starts to decrease at the time point t0, and the front sensor comes to be unable to recognize the traffic participant A at the first time point t1. The driving support ECU 10 starts the prediction (calculation) of the distance ΔY from the first time point t1. After that, the distance ΔY (predicted value) becomes a negative value. That is, the own vehicle passes the traffic participant A. After that, the driver depresses a brake pedal to decelerate the own vehicle in order to turn the own vehicle left at the intersection. Thus, the own vehicle and the traffic participant A start to approach each other from a time point tp. That is, the distance ΔY (predicted value) starts to increase toward “0.” After that, the distance ΔYt2 (predicted value) is equal to or longer than the threshold value ΔYLth and equal to or shorter than the threshold value ΔYHth at the time point t2 (<ΔTth) at which the driver operates the direction indication lever. Thus, in this example, the driving support ECU 10 causes the warning device 30 to execute the warning at the second time point t2.

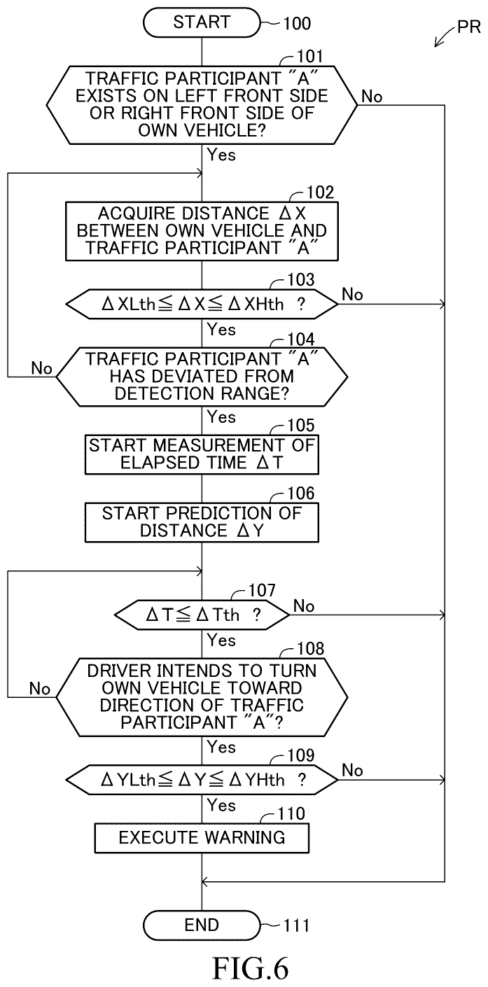

With reference to FIG. 6, a specific description is now given of processing (program PR) executed by the CPU 10a (hereinafter referred to as “CPU”) of the driving support ECU 10 in order to implement the above-mentioned warning function.

The CPU executes the program PR at predetermined cycles when an ignition switch of the own vehicle is in an ON state. The CPU starts the execution of the program PR from Step 100, and advances the process to Step 101.

In Step 101, the CPU determines whether or not a traffic participant A exists on the left front side or the right front side of the own vehicle based on the information acquired from the millimeter wave radar 21 and the camera 22. When a traffic participant A exists on the left front side or the right front side of the own vehicle (Yes in Step 101), the CPU advances the process to Step 102. Meanwhile, when no traffic participant A exists on the left front side or the right front side of the own vehicle (No in Step 101), the CPU advances the process to Step 111, and finishes the execution of the program PR.

In Step 102, the CPU acquires, from the millimeter wave radar 21, the distance ΔX between the own vehicle and the traffic participant A in the vehicle width direction. After that, the CPU advances the process to Step 103.

In Step 103, the CPU determines whether or not the distance ΔX is within the predetermined range (whether or not the distance ΔX is equal to or longer than the lower limit threshold value ΔXLth and equal to or shorter than the upper limit threshold value ΔXHth). When the distance ΔX is within the predetermined range (Yes in Step 103), the CPU advances the process to Step 104. Meanwhile, when the distance ΔX is outside the predetermined range (No in Step 103), the CPU advances the process to Step 111.

In Step 104, the CPU determines whether or not the traffic participant A has deviated from the detection range Ra of the front sensor. For example, when the front sensor (the millimeter wave radar 21 and the camera 22) does not detect the traffic participant A which was detected immediately before, the CPU can determine that the traffic participant A has deviated from the detection range Ra of the front sensor. When the traffic participant A has deviated from the detection range Ra of the front sensor (Yes in Step 104), the CPU advances the process to Step 105. Meanwhile, when the traffic participant A is within the detection range of the front sensor (No in Step 104), the CPU returns the process to Step 102.

In Step 105, the CPU starts the measurement of the elapsed time ΔT. After that, the CPU advances the process to Step 106.

In Step 106, the CPU starts the prediction (calculation) of the distance ΔY between the own vehicle and the traffic participant A in the front-rear direction. After that, the CPU advances the process to Step 107.

In Step 107, the CPU determines whether or not the elapsed time ΔT is equal to or shorter than the threshold value ΔTth. When the elapsed time ΔT is equal to or shorter than the threshold value ΔTth (Yes in Step 107), the CPU advances the process to Step 108. Meanwhile, when the elapsed time ΔT is longer than the threshold value ΔTth (No in Step 107), the CPU advances the process to Step 111.

In Step 108, the CPU determines whether or not “the driver intends to turn the own vehicle toward the side on which the traffic participant exists” based on the information acquired from the direction indication lever sensor 24. When the traffic participant A is positioned on the left side of the own vehicle and the left turn switch transitions to the ON state, or the traffic participant A is positioned on the right side of the own vehicle and the right turn switch transitions to the ON state, the CPU determines that the driver intends to turn the own vehicle to the traffic participant side. When the CPU determines that the driver intends to turn the own vehicle to the traffic participant side (Yes in Step 108), the CPU advances the process to Step 109. Meanwhile, the CPU does not determine that the driver intends to turn the own vehicle to the traffic participant side (No in Step 108), the CPU returns the process to Step 107.

In Step 109, the CPU determines whether or not the distance ΔY (predicted value) is within the predetermined range (whether or not the distance ΔY is equal to or longer than the threshold value ΔYLth and equal to or shorter than the threshold value ΔYHth). When the distance ΔY is within the predetermined range (Yes in Step 109), the CPU advances the process to Step 110. Meanwhile, when the distance ΔY is outside the predetermined range (No in Step 103), the CPU advances the process to Step 111.

In Step 110, the CPU causes the warning device 30 to execute the predetermined warning (the image display and the sound reproduction). After that, the CPU advances the process to Step 111, and finishes the execution of the program PR.

### Effects

When the state in which the own vehicle is positioned in the rear of a traffic participant A and hence the front sensor can recognize the traffic participant A transitions to the state in which the own vehicle approaches the traffic participant A and hence the traffic participant A deviates from the detection range of the front sensor, the front sensor comes to be unable to recognize the traffic participant A. The driving support ECU 10 starts the prediction of the distance ΔY between the own vehicle and the traffic participant A from this time point. Then, when the driving support ECU 10 detects that the driver intends to turn the own vehicle toward the traffic participant side and the own vehicle and the traffic participant A are predicted to be close to each other at this time point (ΔYLth≤ΔY≤ΔYHth), the driving support ECU 10 causes the warning device 30 to execute the warning. As described above, according to the at least one embodiment, even when a device (for example, another vehicle positioned in the rear of the own vehicle) which provides the information on a traffic participant A which cannot be detected by the front sensor of the own vehicle does not exist, the warning can be issued based only on the information acquired by the front sensor mounted to the own vehicle. As a result, the safety of the own vehicle can be increased.

The driving support ECU 10 assumes that the traffic participant A has traveled at the constant speed of the speed vat1 at the first time point t1 (time point at which the determination of “Yes” is made in Step 104) in the period from the first time point t1 to the second time point t2, to thereby predict the distance ΔYt2. Thus, there is a fear that, as the elapsed time ΔT from the first time point t1 increases, a prediction accuracy (correctness) of the distance ΔY may decrease. Thus, the driving support ECU 10 is configured to issue the warning only when the elapsed time ΔT is equal to or shorter than the threshold value ΔTth.

The present invention is not limited to the at least one embodiment described above, and various modification examples can be adopted within the scope of the present invention.

### Modification Example 1

The driving support device 1 may include, in addition to the front sensor, a side sensor capable of acquiring side information which is information on a traffic participant positioned on the lateral side of the own vehicle. For example, as a side sensor, a side camera, an ultrasonic sensor, and the like can be employed. In this case, the driving support ECU 10 starts the prediction of the distance ΔY at the time when the front sensor comes to be unable to detect a traffic participant A as in the at least one embodiment. After that, when the distance ΔY is within a predetermined range at the second time point t2, the driving support ECU 10 acquires, from the side sensor, side information including information on the traffic participant existing on the lateral side of the own vehicle. After that, in addition to the determination processing in Step 109, when the driving support ECU 10 determines that the traffic participant A highly possibly exists on the lateral side of the own vehicle based on determination processing which is based on the side information, the driving support ECU 10 causes the warning device 30 to execute the warning. For example, in Step 109 of FIG. 6, the driving support ECU determines whether or not the distance ΔY (predicted value) is within the predetermined range (range equal to or longer than the lower limit threshold value ΔYLth and equal to or shorter than the upper limit threshold value ΔYHth), and a distance LYS between the own vehicle and the traffic participant A acquired from the side information is equal to or shorter than a predetermined distance. Then, when the distance ΔY is within the predetermined range and the distance LYS is equal to or shorter than the predetermined distance, the driving support ECU may cause the warning device 30 to execute the warning. With this configuration, reliability of the warning can be increased.

### Modification Example 2

In the at least one embodiment, the driving support ECU 10 determines whether or not the driver intends to turn the own vehicle based on the ON state and the OFF state of each of the left turn switch and the right turn switch of the direction indication lever sensor 24. In place of (or in addition to) this configuration, the driving support ECU 10 may use a steering sensor to detect a steering angle of a steering wheel, and may determine whether or not the driver intends to turn the own vehicle based on a result of the detection.

### Modification Example 3

In the at least one embodiment, the driving support ECU 10 assumes that the traffic participant A has traveled at the constant speed of the speed vat1 at (or immediately before) the first time point t1 in the period from the first time point t1 to the second time point t2, to thereby predict the distance ΔYt2. In place of this configuration, the driving support ECU 10 may predict the distance ΔYt2 based on an acceleration and the speed vat1 of the traffic participant A at (or immediately before) the first time point t1.

The vehicle V may be an autonomous vehicle.

What is claimed is:

1. A driving support device, comprising:
a front sensor configured to detect a traffic participant existing in a predetermined region on a left front side and a right front side of an own vehicle, and to acquire information on the traffic participant;
a warning device configured to execute warning for an occupant of the own vehicle; and
a processor configured to control the warning device,
wherein the processor is configured to:
predict, when a turn intention that is an intention of a driver to turn the own vehicle toward a side on which the traffic participant exists is detected within a predetermined time from a first time point at which the front sensor comes to be unable to detect the traffic participant due to deviation of the traffic participant from the predetermined region as a result of approach of the own vehicle to the traffic participant, based on the information on the traffic participant before the first time point, a distance between the traffic participant and the own vehicle in a front-rear direction at a second time point at which the turn intention is detected; and
cause the warning device to execute the warning when the predicted distance between the traffic participant and the own vehicle in the front-rear direction is within a predetermined range.

2. The driving support device according to claim 1, wherein the processor is configured to:
acquire, based on the information on the traffic participant, a distance between the own vehicle and the traffic participant in a vehicle width direction, the distance between the own vehicle and the traffic participant in the front-rear direction, and a speed of the traffic participant in the front-rear direction; and
predict the distance between the traffic participant and the own vehicle in the front-rear direction at the second time point when the processor detects that the distance in the vehicle width direction is equal to or shorter than a predetermined threshold value, and the front sensor comes to be unable to detect the traffic participant due to the deviation of the traffic participant from the predetermined region as a result of a decrease in the distance between the own vehicle and the traffic participant in the front-rear direction.

3. The driving support device according to claim 1, wherein the processor is configured to predict the distance between the traffic participant and the own vehicle at the second time point while assuming that the traffic participant has traveled at a constant speed being a speed at the first time point in a period from the first time point to the second time point.

4. A driving support method, comprising:
detecting a traffic participant existing in a predetermined region on a left front side and a right front side of an own vehicle, and acquiring information on the traffic participant;
predicting, when a turn intention that is an intention of a driver to turn the own vehicle toward a side on which the traffic participant exists is detected within a predetermined time from a first time point at which a front sensor comes to be unable to detect the traffic participant due to deviation of the traffic participant from the predetermined region as a result of approach of the own vehicle to the traffic participant, based on the information on the traffic participant before the first time point, a distance between the traffic participant and the own vehicle in a front-rear direction at a second time point at which the turn intention is detected; and
causing a warning device to execute warning when the predicted distance between the traffic participant and the own vehicle in the front-rear direction is within a predetermined range.

5. A non-transitory storage medium storing a driving support program for causing a computer of an own vehicle to execute:
detecting a traffic participant existing in a predetermined region on a left front side and a right front side of the own vehicle, and acquiring information on the traffic participant;
predicting, when a turn intention that is an intention of a driver to turn the own vehicle toward a side on which the traffic participant exists is detected within a predetermined time from a first time point at which a front sensor comes to be unable to detect the traffic participant due to deviation of the traffic participant from the predetermined region as a result of approach of the own vehicle to the traffic participant, based on the information on the traffic participant before the first time point, a distance between the traffic participant and the own vehicle in a front-rear direction at a second time point at which the turn intention is detected; and
causing a warning device to execute warning when the predicted distance between the traffic participant and the own vehicle in the front-rear direction is within a predetermined range.
